(19) United States
(12) Patent Application Publication
(10) Pub. No.: US 2005/0219980 A1
(43) Pub. Date: Oct. 6, 2005

(54) Data recording and reproducing apparatus, data recording and reproducing method and recording medium

(76) Inventors: Hiroshi Kase, Osaka (JP); Yoshiho Gotoh, Osaka (JP); Harutoshi Miyamoto, Osaka (JP)

Correspondence Address: RATNERPRESTIA, P O BOX 980, VALLEY FORGE, PA, 19482-0980, US

(21) Appl. No.: 11/083,266

(22) Filed: Mar. 17, 2005

Related U.S. Application Data
(60) Provisional application No. 60/559,129, filed on Apr. 2, 2004.

(51) Int. Cl. G11B 5/09

(52) U.S. Cl. 369/53.16; 369/47.14

(57) ABSTRACT

To record video data or audio data on an optical disc on which a defective area exists, there is a method of determining an allowable number of defects in proportion to a recording size and skipping the defective area to use an adjacent area thereto. This method has a problem that the size of the recording area becomes larger by an equivalent of the skipped defective area so as to take a longer time for recording a file, and so convenience for a user is damaged. The size of the defective area allowed in a recording area is limited regardless of the size of the recording area.

### RELATED APPLICATIONS

This application claims priority of U.S. Provisional Application Ser. No. 60/559,129, filed on Apr. 2, 2004.

### BACKGROUND OF THE INVENTION

1. Field of the Invention

The present invention relates to a recording and reproducing apparatus of recording or reproducing video data or audio data by using an optical disc, a method thereof and a recording medium used for the recording and reproducing.

2. Related Art of the Invention

A medium such as a DVD (Digital Versatile Disc) is used as a recording medium of digital data. It is desirable to record a file including video data or audio data, which requires continuous reproduction, in physically contiguous areas on a disc. It is not always possible, however, to record it in the physically contiguous areas because there may be a defective area incapable of recording and reproducing the data on the disc. For this reason, a method of skipping the defective area and using an adjacent normal area is known (refer to Japanese Patent No. 3098237 (pp. 9 to 10, FIG. 1) for instance). FIG. 8 is a diagram showing an example of a layout on the disc in the case of recording a file in a recording area including the defective area. The data in the file is written in sequence to the contiguous areas. In the case where the defective area exists, however, it is written to a next normal area by skipping the defective area. According to this method, there is a merit that time of interruption on reading the data from the disc can be kept to a minimum.

According to the method, however, the size of the recording area becomes larger by an equivalent of the skipped defective area. It is because the area where a pickup records or passes in a data recording operation becomes a size totaling the size of the data to be recorded and the size of the skipped defective area due to detective area.

The case of setting an allowable number of defects in proportion to a recording area size will be considered. For instance, it is assumed that the allowable number of defective areas per recording area of 100 Mbits is 50 pieces. In this regard, Table 2 shows recording time and lost time in the case of recording two files of different data rates for 100 seconds in the area where five pieces of defective area per 10 Mbits are uniformly distributed. Here, data recording on the disc is performed at 11.08 Mbps.

TABLE 2

| | | Number of | | | |
|---|---|---|---|---|---|
| | | defective | Recording | Recording | |
| Bit rate | File size | areas | size | time | Lost time |
| 1 Mbps | 100 Mbits | 50 pieces | 113 Mbits | 10 seconds | 1 |
| | | | | | second |
| 9 Mbps | 900 Mbits | 450 pieces | 1018 Mbits | 92 seconds | 11 |
| | | | | | seconds |

Table 2 shows the case where, in a prior art, a file of which data rate is 1 Mbps and a file of which data rate is 9 Mbps are recorded for 100 seconds in the area where the allowable number of defective areas per recording area of 100 Mbits is 50 pieces and five pieces of defective area per 10 Mbits are uniformly distributed.

Thus, the recording area (recording size) used on recording the data becomes larger as the number of the defective areas increases, and furthermore, the time required for skipping (lost time) becomes longer as the number of the defective areas increases. For this reason, there is a problem that the time required to record the file is significantly extended.

There are also the cases where, when a reproducing apparatus reproduces the file, a buffer underflow occurs and reproduced video and audio are interrupted if the area where the data is recorded is fragmented due to the defective areas in the recording area and so on. FIG. 9 is a diagram showing an example of the buffer underflow. Thus, there is a problem that, in the defective area having no data recorded, a data amount accumulated in a buffer in the reproducing apparatus may become empty and so convenience for a user may be significantly damaged.

### SUMMARY OF THE INVENTION

The present invention has been implemented in consideration of the problems.

A recording method of the present invention is the recording method of recording real-time data including at least one of audio data and video data in a minimum unit of a sector on an information recording medium, the method comprising steps of:

searching for unallocated areas on which the data can be recorded;

recording the data in the unallocated areas searched for;

examining the size of an unusable area existing in a predetermined section including the unallocated areas searched for so as to check whether it exceeds a predetermined size;

in the step of checking whether it exceeds the predetermined size, moving on to the step of searching for the unallocated areas in order to search for a new unallocated area in the case where a condition is not satisfied, and moving on to the step of recording the data in the unallocated areas searched for in the case where the condition is satisfied.

Furthermore, the unusable area existing in a predetermined section including the unallocated area searched for is the area including a defective sector possibly incapable of recording the data so that the data may be recorded by avoiding the area including a defective sector possibly incapable of recording the data.

Furthermore, the predetermined size may be determined so that the size of the unusable area allowed to exist in the predetermined section including the unallocated area searched for will be a small ratio to the size of the predetermined section in the case where a data rate of real-time data to be recorded is high and will be a large ratio in the case where the data rate is low.

Furthermore, the predetermined size may be determined so that the size of the unusable area allowed to exist in the predetermined section including the unallocated area searched for will be the predetermined size to the size of the predetermined section regardless of the data rate.

A recording apparatus according to the present invention is the recording apparatus of recording the real-time data including at least one of the audio data and the video data in the minimum unit of a sector on an information recording medium, the apparatus comprising means of:

searching for unallocated areas on which the data can be recorded;

recording the data in the unallocated areas searched for;

examining the size of the unusable area existing in the predetermined section including the unallocated areas searched for so as to check whether it exceeds a predetermined size;

in the means of checking whether it exceeds the predetermined size, moving on to a search for the unallocated areas in order to search for a new unallocated area in the case where the condition is not satisfied, and moving on to recording of the data in the unallocated areas searched for in the case where the condition is satisfied.

Furthermore, the unusable area existing in a predetermined section including the unallocated area searched for is the area including the defective sector possibly incapable of recording the data so that the data may be recorded by avoiding the area including the defective sector possibly incapable of recording the data.

Furthermore, the predetermined size may be determined so that the size of the unusable area allowed to exist in the predetermined section including the unallocated area searched for will be a small ratio to the size of the predetermined section in the case where the data rate of the real-time data to be recorded is high and will be a large ratio in the case where the data rate is low.

Furthermore, the predetermined size may be determined so that the size of the unusable area allowed to exist in the predetermined section including the unallocated area searched for will be the predetermined size to the size of the predetermined section regardless of the data rate.

A recording medium according to the present invention is the recording medium having the real-time data including at least one of the audio data and the video data in the minimum unit of a sector recorded thereon, characterized in that the size of the unused area existing in the predetermined section including the area where the data is recorded is the predetermined size or smaller.

Furthermore, the unused area existing in the predetermined section including the recorded area may be the area including the defective sector possibly incapable of recording the data.

Furthermore, the predetermined size may be determined so that the size of the unused area allowed to exist in the predetermined section including the recorded area will be a small ratio to the size of the predetermined section in the case where the data rate of the recorded real-time data is high and will be a large ratio in the case where the data rate is low.

Furthermore, the predetermined size may be determined so that the size of the unused area allowed to exist in the predetermined section including the recorded area will be the predetermined size to the size of the predetermined section regardless of the data rate.

A reproducing apparatus according to the present invention is the reproducing apparatus of reproducing the data from the recording medium having the real-time data including at least one of the audio data and the video data in the minimum unit of a sector recorded thereon, the apparatus reproducing the data from the recording medium in which the size of the unused area existing in the predetermined section including the area where the data is recorded is the predetermined size or smaller.

Furthermore, the unused area existing in the predetermined section including the recorded area may be the area including the defective sector possibly incapable of recording the data.

Furthermore, the predetermined size may be determined so that the size of the unused area allowed to exist in the predetermined section including the recorded area will be a small ratio to the size of the predetermined section in the case where the data rate of the recorded real-time data is high and will be a large ratio in the case where the data rate is low.

Furthermore, the predetermined size may be determined so that the size of the unused area allowed to exist in the predetermined section including the recorded area will be the predetermined size to the size of the predetermined section regardless of the data rate.

A reproducing method according to the present invention is the reproducing method of reproducing the data from the recording medium having the real-time data including at least one of the audio data and the video data in the minimum unit of a sector recorded thereon, characterized in that the data is reproduced from the recording medium in which the size of the unused area existing in the predetermined section including the area where the data is recorded is the predetermined size or smaller.

Furthermore, the unused area existing in the predetermined section including the recorded area may be the area including the defective sector possibly incapable of recording the data.

Furthermore, the predetermined size may be determined so that the size of the unused area allowed to exist in the predetermined section including the recorded area will be a small ratio to the size of the predetermined section in the case where the data rate of the recorded real-time data is high and will be a large ratio in the case where the data rate is low.

Furthermore, the predetermined size may be determined so that the size of the unused area allowed to exist in the predetermined section including the recorded area will be the predetermined size to the size of the predetermined section regardless of the data rate.

The present invention has the effects that, in the case of recording the video data or the audio data while avoiding the defective areas on the disc, waste of the recording time is limited and the convenience for the user is improved, and the recording area suited to the bit rate of the data to be recorded can be secured so as to realize an effective layout on the disc. In particular, it has the following effects.
The data of a low bit rate is recordable in the area dense with the defective areas so that usability of the disc is improved.
The data of a high bit rate is placed in the area not dense with the defective areas so that the lost time is reduced and the convenience for the user is improved.

Furthermore, it has the effect of being able to assure that no buffer underflow occurs in the recording area.

### BRIEF DESCRIPTION OF THE DRAWINGS

FIG. 1 is a diagram showing an example of a data layout on the disc in the case of recording a file of 1 Mbps.

FIG. 2 is a diagram showing an example of the data layout on the the disc in the case of recording the file of 9 Mbps.

FIG. 3 shows an example of the disc considered in an embodiment of the present invention.

FIG. 4 is a schematic view showing a configuration of a disc recording apparatus.

FIG. 5 is a block diagram showing functions used to record the files.

FIG. 6 is a flowchart showing a recording process of the file.

FIG. 7 is a model view showing a relationship between normal areas and defective areas.

FIG. 8 is a diagram showing an example of the layout on the disc in the case of recording the file in the recording area including the defective area.

FIG. 9 is a diagram showing an example of the buffer underflow.

Designation of Reference Numerals

41 Personal computer
42 Keyboard/mouse
43 Display
44 Speaker
45 Hard disk
46 Optical disc drive
411 CPU
412 Memory
50 Recording and reproducing apparatus
51 Disc
52 File
501 Recording area management means
502 Unrecorded area search means
503 Number of defects counting means
504 Recording and reproducing means

### PREFERRED EMBODIMENTS OF THE INVENTION

(Configuration of the Recording Medium)

A recordable optical disc used for the present invention (hereafter, abbreviated as a disc) will be described.

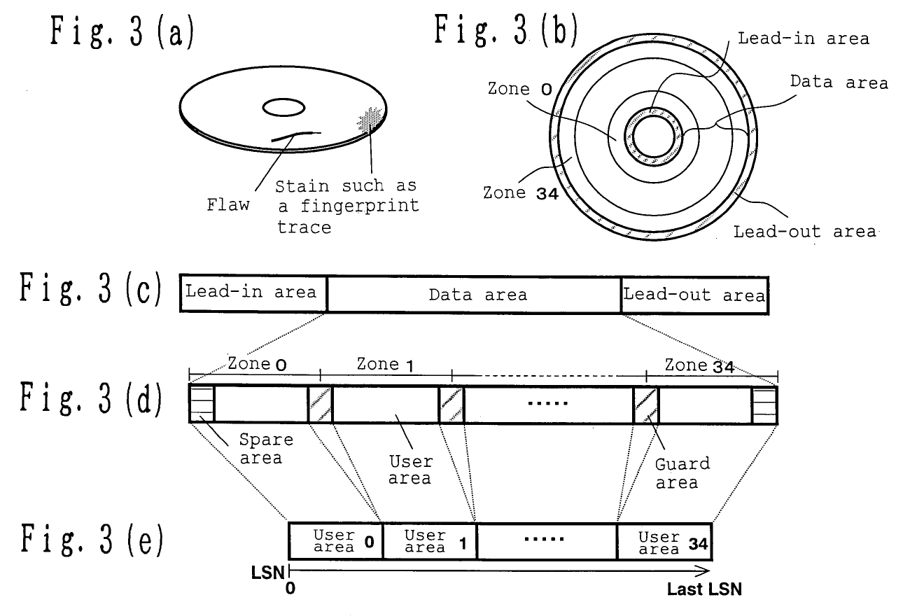

FIG. 3 shows an example of the disc considered in the present invention.

As shown in FIG. 3 (a), there are the cases where defective areas are generated on the disc due to flaws, fingerprint traces and so on. There are also the defective areas existing in an initial state (not shown). As for concrete examples of the discs, there are CD-R, CD-RW, DVD-R, DVD-RW, DVD-RAM, DVD+R, DVD+RW and so on.

Of the DVD-RAMs, the one of which recording capacity is B 4.7 GB will be described in this embodiment.

A minimum access unit of data on the disc is 2048 bytes which is called a sector. A unit comprised of 16 consecutive sectors is called a block. A file recorded on the disc is comprised of a group of sectors.

FIG. 3 (b) is a schematic view showing a layout of areas of the DVD-RAM.

The DVD-RAM is managed as a lead-in area, a data area and a lead-out area from an inner circumference side. And the data area is further divided into 35 concentric areas called zones. FIG. 3 (c) represents the layout of the areas like a zone along a track on the disc, where the left end is equivalent to an innermost circumference of the disc and the right end is equivalent to an outermost circumference of the disc. Physical sector numbers being 0 at the left end are allocated to all the sectors on the disc in ascending order, and a recording and reproducing apparatus can access an arbitrary sector on the disc by means of the physical sector numbers. The lead-in area and the lead-out area have reference signals, identification signals and so on required for the recording and reproducing apparatus of the DVD-RAM recorded therein.

As shown in FIG. 3 (d), the data area is further divided into the zones. Though rotational speed of the DVD-RAM is different in each zone, it is constant inside the zone. In the case of the DVD-RAM of 4.7 GB, there are 35 zones which are managed as a zone 0 to a zone 34 from the inner circumference side. A guard area is provided on a boundary between the zones, and spare areas are provided at the top portion of the zone 0 and the end portion of the zone 34. The other areas are allocated as user areas. The guard area is provided not to interrupt operation on switching the zones, and is not used to record the data. There are the cases where, if the defective area exists in the user area, the spare area becomes an alternative area and is used as the user area.

As shown in FIG. 3 (e), logical sector numbers (LSNs) are allocated so as to consecutively indicate only the sectors used for recording except the sectors such as the guard areas and defective areas not used for recording.

Next, a slip replacement and a linear replacement will be described as replacement methods of replacing the defective areas on the disc with normal areas.

The slip replacement is performed on formatting or certifying the disc, where the defective sectors are registered with management information so as not to be used, and the spare areas are used to make up for the normal area corresponding to the defective sectors and the LSNs are allocated to usable sectors. Both the LSNs and physical sector numbers are allocated in ascending order from the inner circumference to the outer circumference, and so no significant seek arises since the defective sector is skipped even if there exists one.

The linear replacement is used on replacing the defective block discovered while recording, where the discovered defective block is invalidated and the LSNs allocated to that block are reallocated to the normal block in the spare area. For this reason, the physical sector numbers corresponding to the LSNs are not necessarily in ascending order, and there is a possibility that a significant seek may arise. Thus, according to the embodiment of the present invention, the linear replacement is only applied to the recording of the file which does not require real-time reproduction, and is not used on recording the file including the video data or audio data which requires the real-time reproduction.

As for the defective areas, there are sector defects, block defects and so on. The defective areas may also be included in the areas not used for recording.

(Configuration of the Recording and Reproducing Apparatus)

Next, the configuration of the recording and reproducing apparatus according to the embodiment of the present invention will be described.

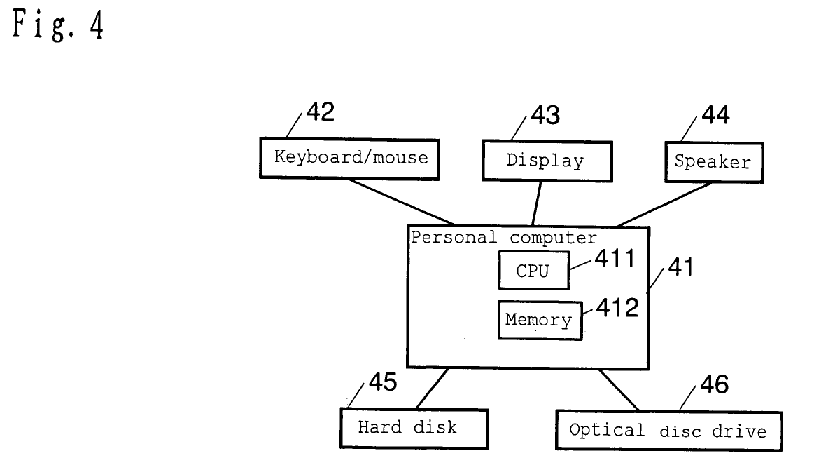

FIG. 4 is a schematic view showing the configuration of the recording and reproducing apparatus of the present invention.

A personal computer 41 has peripherals connected thereto, such as a keyboard and a mouse 42 as input devices, a display 43 as a display unit, a speaker 44 of performing an audio output, a hard disk 45 as the recording apparatus and an optical disc drive 46 of performing the recording and reproduction of the discs. They are controlled by a CPU 411 furnished inside the personal computer 41, and a memory 412 temporarily stores a driver of exerting control, software such as an operation system and an application program, the data to be recorded and reproduced on the peripherals and so on.

The files including the video data and audio data are recorded on the hard disk. The user can start the application program by operating the mouse or the like and designate the file on the hard disk so as to reproduce the video and audio on the display and the speaker. It is also possible to record these files on the disc inserted in the optical disc drive. Furthermore, it is also possible to reproduce the files recorded on the disc as in the case of the hard disk.

(Recording Method)

Next, a recording method according to the embodiment of the present invention will be described by referring to FIGS. 4, 5 and 6.

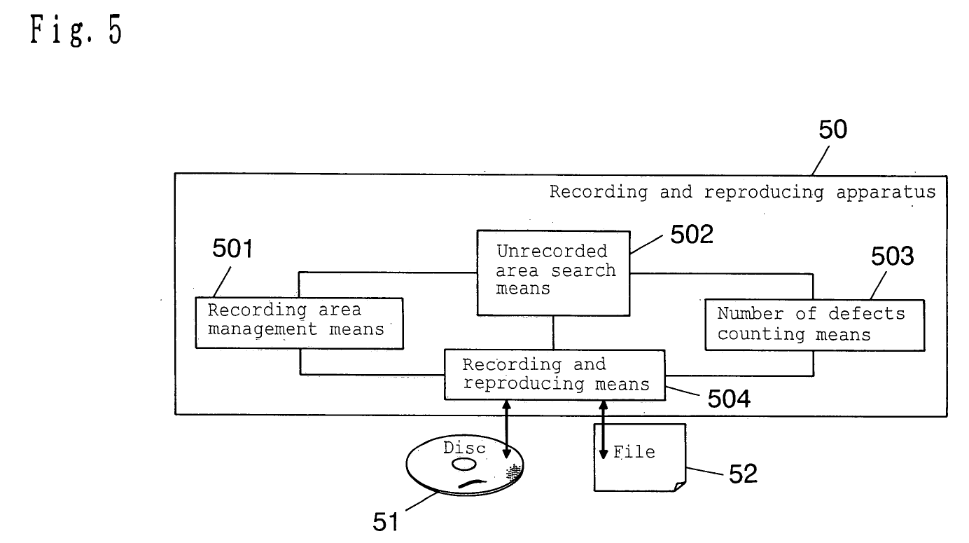

FIG. 5 is a block diagram showing functions used to record the files.

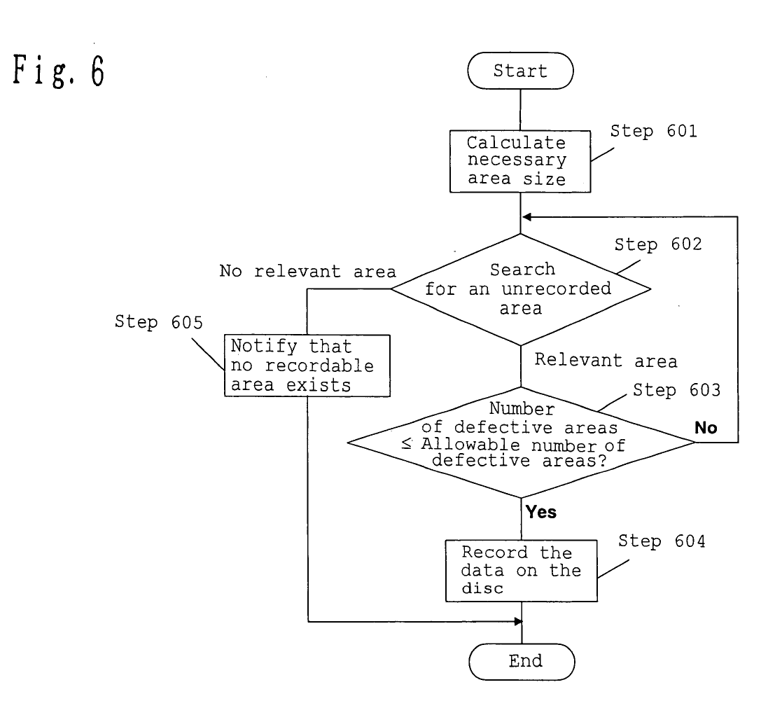

FIG. 6 is a flowchart showing a recording process of the file.

In FIG. 5, a recording and reproducing apparatus 50 is equivalent to the personal computer 41 in FIG. 4, a disc 51 is the disc inserted into an apparatus equivalent to the optical disc drive 46 in FIG. 4, and a file 52 is the file stored in a storage area equivalent to the hard disk 45 or the memory 412 in FIG. 4.

In the recording and reproducing apparatus 50, if instructed to record the file on the disc, recording area management means 501 accesses the file via recording and reproducing means 504 and extracts a bit rate and reproduction time as the information necessary to secure the recording area. The information may also be extracted from a different file from a subject of recording (a management file of managing the information on the files including the video data and audio data, for instance). It calculates the size necessary to be secured as the recording area from the information and the allowable number of defective areas to be allowed in the recording area, and notifies unrecorded area search means 502 of that value (step 601) To be more precise, it should be a value of the size calculated by (bit rate×file reproduction time+allowable number of defective areas×defective area size) or larger. In the case where the defective area is in the unit of a block, the defective area size is the block size. And in the case where the defective area is in the unit of a sector, the defective area size is the sector size. The information on the allowable number of defective areas may be either held in advance by the recording area management means 501 or inputted to the recording and reproducing apparatus 50 by the user. Or else, in the case where the information on the allowable number of defective areas is written on the disc, that information may be used.

Next, the unrecorded area search means 502 refers to the management information on the disc via the recording and reproducing means 504, and searches for an unrecorded area satisfying the size notified by the recording area management means 501 (step 602). Consequently, if a relevant area does not exist, it sends a notice to the effect that no recordable area exists (step 605) and finishes the process.

Number of defects counting means 503 checks the number of the defective areas existing in the area searched for by the unrecorded area search means 502 via the recording and reproducing means 504 so as to determine whether or not the number of the defective areas is the allowable number of defective areas or less (step 603). If the condition is satisfied (step 603: Yes), it determines the area to be the recordable area and notifies the recording and reproducing means 504 that the recording area is the recordable area. If the condition is not satisfied (step 603: No), it sends a notice to the unrecorded area search means 502 to the effect that a new recording area should be searched for.

The recording and reproducing means 504 records the data in the recording area according to the notice (step 604).

It is possible, according to the above configuration, to limit the number of the defects included in the unrecorded area to a predetermined number or less and then write the file to the disc.

In the step 603, it is checked that the number of the defective areas existing in one unrecorded area searched for in the step 602 is the predetermined allowable number of defective areas or less. However, it is not limited thereto. It is also possible to search for a plurality of unrecorded areas on which the data can be recorded in the step 602, and search for a plurality of unrecorded areas so that the size of predetermined consecutive sections comprised of at least one unrecorded area searched for and unusable areas existing before and after it (the areas already being used or being defective (including the sectors possibly incapable of recording)) will be larger than (bit rate×file reproduction time+allowable number of defective areas×defective area size). Next, in the step 603, the size of the areas not used for the recording of the data may be examined in the predetermined consecutive sections so as to check whether or not that size exceeds the predetermined allowable number of defective areas. In this case, if the condition is not satisfied, it moves on to the step 602 in order to search for a new unrecorded area. And if the condition is satisfied, it moves on to the step 604 so as to record the data in the unrecorded area searched for.

In the step 603, it is also possible to perform the check by rendering a ratio of the allowable defective areas to the predetermined recording area lower when a data rate of the data to be recorded is high and rendering that ratio higher when the data rate is low.

The allowable number of defective areas may be set in advance of the recording of real-time data to be recorded, and may also be the predetermined number in the predetermined consecutive sections.

(Example of Data Layout on the Disc)

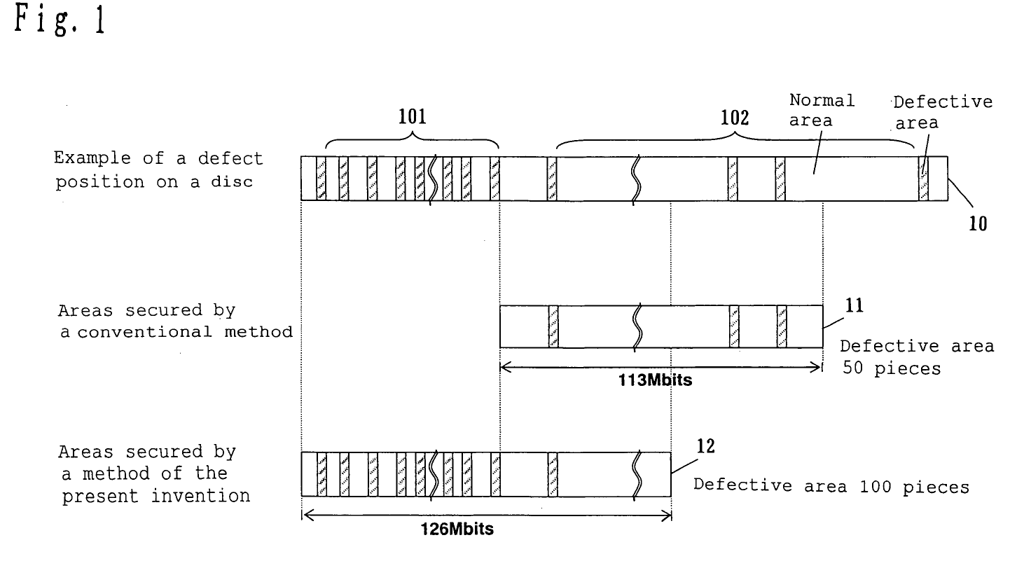

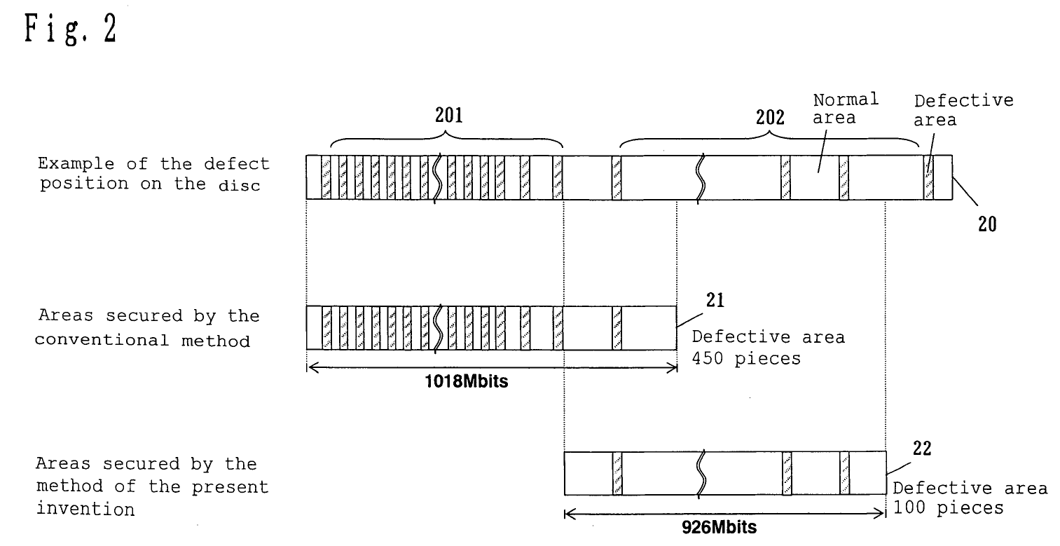

Next, a description will be given by using FIGS. 1 and 2 as to the data layout on the disc according to the embodiment of the present invention. As an example of the recording of the present invention, Table 1 shows the recording time and lost time in the case where the allowable number of defects in the recording area is 100 pieces and the files of the data rates of 1 Mbps and 9 Mbps are recorded for 100 seconds respectively. Here, data recording on the disc is performed at 11.08 Mbps.

TABLE 1

| | | Number of | | | | |
|---|---|---|---|---|---|---|
| | | defective | Recording | | | Difference |
| Bit rate | File size | areas | size | Recording time | Lost time | from the past |
| 1 Mbps | 100 Mbits | 100 pieces | 126 Mbits | 11 seconds | 2 seconds | 1 second |
| 9 Mbps | 900 Mbits | 100 pieces | 926 Mbits | 84 seconds | 2 seconds | −8 seconds |

Table 1 shows the case where the allowable number of defects in the recording area is 100 pieces and the files of the data rates of 1 Mbps and 9 Mbps are recorded for 100 seconds respectively.

FIG. 1 is a diagram showing an example of a data layout on the disc in the case of recording the file of 1 Mbps. To make a comparison easier, an example of the recording by the past method in Table 2 and an example of the recording by the recording method of the present invention in Table 1 are shown together.

An unrecorded area 10 schematically shows the unrecorded area on the disc, where shaded areas in the unrecorded area 10 indicate the defective areas and the rest indicates the normal areas. An area 101 is the area where there are 100 pieces of the defective area per 100 Mbits and an area 102 is the area where there are 50 pieces of the defective area per 100 Mbits. And the recording process of the data is performed in sequence from the left to the right.

A recording area 11 is an example of the data layout obtained in the case of recording by the past method shown in Table 2, which extracts and illustrates the portion used as the recording area from the unrecorded area 10.

A recording area 12 is an example of the data layout obtained in the case of recording by the method of the present invention shown in Table 1, which extracts and illustrates the portion used as the recording area from the unrecorded area 10.

A search for the recording area is made from the left end of the unrecorded area 10. In the case of the past method, the allowable number of defects per predetermined size is fixed, such as 50 pieces of allowable defects per 100 Mbits as shown in Table 2 for instance. For this reason, the area 101 which does not fall under this condition is unusable. Therefore, the data is recordable in the area 102 which falls under this condition.

In the case of the method of the present invention, the allowable number of defects per recording area is fixed irrespective of the file size. In the case of Table 1, it is 100 pieces per recording area. For this reason, in the case of recording the data of which bit rate is 1 Mbps, the area 101 also falls under this condition so that the data is recordable.

Thus, it is possible, by the method of the present invention, to record the data even in the area where the defective areas exist rather densely particularly as to the files of low bit rates so that the unrecorded areas on the disc can be effectively exploited.

FIG. 2 is a diagram showing an example of the data layout on the disc in the case of recording the file of 9 Mbps.

An unrecorded area 20 schematically shows the unrecorded area on the disc, where shaded areas in the unrecorded area 20 indicate the defective areas and the rest indicates the normal areas. An area 201 is the area where there are 450 pieces of the defective area per 900 Mbits and an area 202 is the area where there are 100 pieces of the defective area per 900 Mbits. And the recording process of the data is performed in sequence from the left to the right.

A recording area 21 is an example of the data layout obtained in the case of recording by the past method shown in Table 2, which extracts and illustrates the portion used as the recording area from the unrecorded area 20.

A recording area 22 is an example of the data layout obtained in the case of recording by the method of the present invention shown in Table 1, which extracts and illustrates the portion used as the recording area from the unrecorded area 20.

A search for the recording area is made from the left end of the unrecorded area 20. In the case of the past method, the allowable number of defects per predetermined size is fixed, such as 50 pieces of allowable defects per 100 Mbits as shown in Table 2 for instance. For this reason, the data is recorded in the area 201 which falls under this condition.

In the case of the method of the present invention, the allowable number of defects per recording area is fixed irrespective of the file size. In the case of Table 1 for instance, it is 100 pieces per recording area. For this reason, in the case of recording the data of which bit rate is 9 Mbps, the area 201 does not fall under this condition but the area 202 falls under this condition so that the data is recordable therein.

Thus, according to the method of the present invention, the files of high bit rates are recorded by avoiding the area where the defective areas exist rather densely. For this reason, it is possible to secure the area of less lost time so as to reduce the recording time.

The “difference from the past” in Table 1 indicates the difference between the recording time by the past method and that by the method of the present invention shown in Table 2. And the present invention has the following advantage.

In the case of the file of 9 Mbps, it takes 92 seconds by the past method but it takes only 84 seconds by the method of the present invention. Thus, the time is reduced by 8 seconds.

In the case of the file of 1 Mbps, it takes 10 seconds of the recording time by the past method but it takes 11 seconds by the method of the present invention. Thus, it takes one extra second.

To be more specific, the recording time is significantly reduced at the high bit rates, and it is extended a little at the low bit rates. However, it is at a non-problematic level as regards sensible time for the user.

Thus, in the case of mutually comparing the data of the same reproduction time, the size of allowable defective areas is determined to be at a relatively small ratio to the size of the entire recording area in the case of the high bit rates and at a relatively large ratio in the case of the low bit rates so as to have the above effects.

(Avoiding the Buffer Underflow Due to the Defective areas)

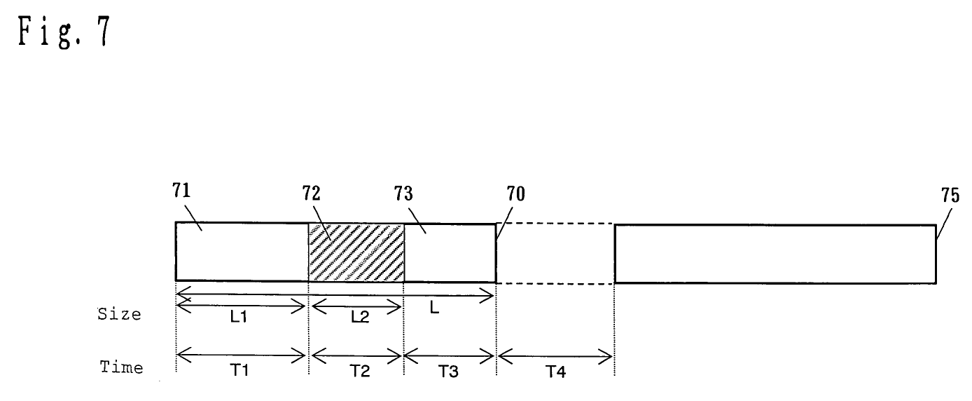

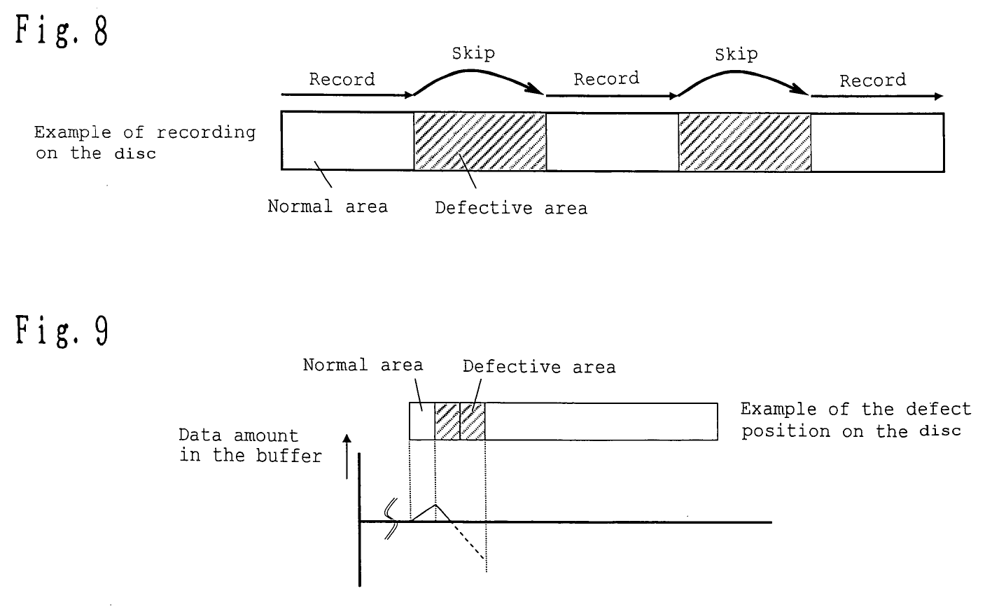

Next, a description will be given by referring to FIGS. 7 as to the recording method of avoiding the buffer underflow according to the embodiment of the present invention.

Even in the case where the size of the unused areas such as the defective area allowable in the predetermined section is determined, the buffer underflow occurs before accumulating a sufficient amount of data in the buffer on reproduction if the unused areas are gathering at the top portion of the area where the reproduction is to be started. This recording method is intended to avoid it.

FIG. 7 is a model view showing a relationship between the normal areas and the defective areas.

Normal areas 71, 73 and a defective area 72 exist in a recording area 70 on the disc. The normal area 71 has a size of L1 megabits, and the time necessary to read it from the disc on the reproducing apparatus is T1 seconds. Likewise, the read time for the defective area 72 is T2 seconds.

And read speed of the reproducing apparatus (equivalent to write speed to the buffer) is Vr bits per second and read speed from the buffer is Vo bits per second, where the value of Vr is larger than Vo. If the reproducing apparatus starts the reproduction of the recording area 70, the data is read from the disc at the speed Vr in the normal areas 71 to be written to the buffer. At the same time, the data is read from the buffer at the speed Vo. In the defective area 72, the data is not read from the disc but is skipped so that no data is written to the buffer. However, the data is read from the buffer at the speed Vo. To be more specific, the data is accumulated in the buffer at the speed (Vr−Vo) in the normal area 71, and the data accumulated in the buffer is consumed at the speed Vo in the defective area 72.

Thus, the condition of avoiding the buffer underflow in the recording area 70 is represented as follows.
(Vr−Vo)×T1≧Vo×T2

And the size of the normal area 71 is represented as follows.
L1=Vr×T1

Thus, the condition of avoiding the buffer underflow is represented as follows.
L1≧(Vo×T2)/(1−(Vo/Vr))

To be more specific, it is possible to avoid the buffer underflow by forming the recording area in which the size of the normal area immediately before the defective area is L1 or larger according to the time T2 of skipping the defective area.

(Avoiding the Buffer Underflow by Dividing the Recording Areas)

Next, a description will be given as to an example of applying the recording method of the present invention on recording the file by dividing it into a plurality of areas on the disc.

In the case where the recording and erasure of the file on the disc is repeated, free space on the disc is dispersed in a plurality of areas. As for the DVD-RAM, there are the cases where the file is recorded astride the guard area between the zones. In the case of recording the data on the disc with the dispersed free space or the disc of a zone structure, it is inevitable to record the file by dividing it into a plurality of physically consecutive areas.

FIG. 7 shows the case where there is the area unusable for recording between the recording area 70 and a recording area 75. Here, the read speed of the reproducing apparatus (equivalent to write speed to the buffer) is Vr bits per second and read speed from the buffer is Vo bits per second, where the value of Vr is larger than Vo. In this case, the data is accumulated in the buffer at the speed Vr−Vo while reproducing the normal areas 71 and 73, and the data is consumed from the buffer at the speed Vo in the defective area 72 and the area between the recording area 70 and the recording area 75.

To avoid occurrence of the buffer underflow while a pickup accesses from the recording area 70 to the recording area 75, the data of the buffer accumulated while reproducing the recording area 70 should be equal to or more than the data consumed while the pickup accesses from the recording area 70 to the recording area 75. Thus, the condition thereof is represented as follows.
(Vr−Vo)×(T1+T3)−Vo×T2≧Vo×T4

Here, the normal area 71 has the size of L1 megabits, and the time necessary to read it from the disc on the reproducing apparatus is T1 seconds. Likewise, the defective area 72 has the size of L2 megabits, and the time necessary to read it is T2 seconds. The recording area 70 has the size of L megabits. The time necessary to read the normal area 73 from the disc on the reproducing apparatus is T3 seconds. The recording area 70 and the recording area 75 are at physically distant locations on the disc, and the time necessary for the optical pickup to jump from the end of the recording area 70 to the top of the recording area 75 is T4 seconds.

And the size of the recording area 70 is represented as follows.
L=Vr×(T1+T3)+L2

Thus, on recording the data in the two distant recording areas, the size of each individual recording area only needs to satisfy the following condition.
L≧L2+(Vo×(T2+T4))/(1−(Vo/Vr))

In the case of reproducing the file recorded by satisfying the condition, it is assured that no buffer underflow occurs even if the file is recorded by dividing it into a plurality of areas.

Thus, the limit on the allowable number of defective areas of the present invention is applied to each recording area acquired by the above consideration. For instance, if the condition of the size of the recording areas is applied to the file of the bit rate of 1 Mbps, it becomes as follows.
L≧7.5 Mbits

Here, it is as follows.
L2=(32768×8×20)/1000000
T2=(23.6/1000)×20
T4=1.5
Vo=1
Vr=11.08
The defective areas exist in the units of blocks, and the allowable number of defective areas in each recording area is 20 pieces. The above is equivalent to the case where 20 pieces of defect consecutively exist.

The area 101 in FIG. 1 is the area where 100 pieces of defective area exist per 100 Mbits, and there is one piece of defect per Mbit on average. When L=7.5 Mbits, the number of defects in this recording area is 7.5 pieces. As the allowable number of defective areas is 20 pieces, it is possible to record the data in the recording area including so many defective areas.

If it is applied to the file of the bit rate of 9 Mbps, it becomes as follows.
L≧100 Mbits
Here, the allowable number of defective areas is 20 pieces.

The area 201 in FIG. 2 is the area where there are 450 pieces of the defective area per 900 Mbits, and there is 0.5 piece of defect per Mbit on average. When L=100 Mbits, the number of defects in the recording area is 50 pieces on average. As the allowable number of defective areas is 20 pieces, it is impossible to secure the recording area in the area 201.

The area 202 is the area where 100 pieces of defective area exist per 900 Mbits, and there is 0.12 piece of defect per Mbit on average so that the number of defects in the recording area is 12 pieces on average. As the allowable number of defective areas is 20 pieces, it is possible to use this recording area.

Thus, when the rate of the data to be recorded is high, the recording area with few defective areas is secured so as to reduce the lost time on recording.

As above, it is possible to apply the present invention to each recording area so as to implement an efficient data layout on the disc.

Here, the case of one defective area in the recording area is taken as an example. However, it may be considered likewise even if a plurality of defective areas are dispersed therein.

And the defective area due to the slip replacement may exist in the portion of the normal area 73. In this case, the above L2 and T2 include a skip size and a skip time of the slip replacement respectively.

According to the present invention, the lost read time on reproduction is also reduced. Thus, the reproducing method or the reproducing apparatus of the disc recorded by the present invention is capable of efficient reproduction by holding down a buffer amount compared with the past.

The embodiment of the present invention showed the configuration with the personal computer. However, it may be a dedicated apparatus such as a DVD player or a DVD recorder having equivalent functions.

It is also possible to implement with hardware the contents implemented by software.

The files are inputted and outputted to the memory from the hard disk and optical disc. However, it is also possible to input and output the files to a network connected to the personal computer.

While the recording method and the recording apparatus are described above, the recording medium on which recording has been performed by the above-mentioned recording method and the recording apparatus reflects characteristics of the present invention. To be more specific, it is the recording medium having the real-time data including at least one of the audio data and the video data in the minimum unit of a sector recorded thereon, and it is determined that the size of the unused area including the defective sector and so on existing in the predetermined section including the area where the data is recorded is the predetermined size or smaller, or a small ratio to the size of the predetermined section in the case where the data rate of the recorded real-time data is high and a large ratio in the case where the data rate is low. Therefore, it is the recording medium having the same effects as mentioned above.

The reproducing method or reproducing apparatus of reproducing with the above-mentioned recording medium can also perform the reproduction reflecting characteristics of the present invention. To be more specific, it reproduces with the recording medium having the real-time data including at least one of the audio data and the video data in the minimum unit of a sector recorded thereon, and it is determined that the size of the unused area including the defective sector and so on existing in the predetermined section including the area where the data is recorded is the predetermined size or smaller, or a small ratio to the size of the predetermined section in the case where the data rate of the recorded real-time data is high and a large ratio in the case where the data rate is low. Therefore, it is the reproducing method or reproducing apparatus having the above-mentioned effects likewise.

The recording method, recording apparatus, recording medium, reproducing apparatus and reproducing method of the present invention can be effectively used for the recording media such as the optical disc, a magnetic disc and a magnetic optical disc, and a player and a recorder capable of recording or reproducing with the recording media and a computer with drives capable of recording or reproducing with the recording media.

1. A recording method of recording real-time data including at least one of audio data and video data in a minimum unit of a sector on an information recording medium, characterized in that the method comprising steps of:
searching for unallocated areas on which the data can be recorded;
recording the data in the unallocated areas searched for;
examining the size of an unusable area existing in a predetermined section including the unallocated areas searched for so as to check whether it exceeds a predetermined size; and
wherein, in the step of checking whether it exceeds the predetermined size, moving on to the step of searching for the unallocated areas in order to search for a new unallocated area in the case where a condition is not satisfied, and moving on to the step of recording the data in the unallocated areas searched for in the case where the condition is satisfied.

2. The recording method according to claim 1, characterized in that:
the unusable area existing in the predetermined section including the unallocated area searched for is the area including a defective sector possibly incapable of recording the data so that the data is recorded by avoiding the area including the defective sector possibly incapable of recording the data.

3. The recording method according to claim 1, characterized in that:
the predetermined size is determined so that the size of the unusable area allowed to exist in the predetermined section including the unallocated area searched for is a small ratio to the size of the predetermined section in the case where a data rate of real-time data to be recorded is high and is a large ratio in the case where the data rate is low.

4. The recording method according to claim 3, characterized in that:
the predetermined size is determined so that the size of the unusable area allowed to exist in the predetermined section including the unallocated area searched for is the predetermined size to the size of the predetermined section regardless of the data rate.

5. A recording apparatus of recording real-time data including at least one of audio data and the video data in a minimum unit of a sector on an information recording medium, characterized in that the apparatus comprising:
means of searching for unallocated areas on which the data can be recorded;
means of recording the data in the unallocated areas searched for;
means of examining the size of the unusable area existing in the predetermined section including the unallocated areas searched for so as to check whether it exceeds a predetermined size;
wherein, in the means of checking whether it exceeds the predetermined size, moving on to a search for the unallocated areas in order to search for a new unallocated area in the case where a condition is not satisfied, and moving on to recording of the data in the unallocated areas searched for in the case where the condition is satisfied.

6. The recording apparatus according to claim 5, characterized in that the unusable area existing in the predetermined section including the unallocated area searched for is the area including the defective sector possibly incapable of recording the data so that the data is recorded by avoiding the area including the defective sector possibly incapable of recording the data.

7. The recording apparatus according to claim 5, characterized in that the predetermined size is determined so that the size of the unusable area allowed to exist in the predetermined section including the unallocated area searched for is a small ratio to the size of the predetermined section in the case where the data rate of the real-time data to be recorded is high and is a large ratio in the case where the data rate is low.

8. The recording apparatus according to claim 7, characterized in that the predetermined size is determined so that the size of the unusable area allowed to exist in the predetermined section including the unallocated area searched for is the predetermined size to the size of the predetermined section regardless of the data rate.

9. A recording medium having real-time data including at least one of audio data and video data in a minimum unit of a sector recorded thereon, characterized in that the size of the unused area existing in a predetermined section including an area where the data is recorded is the predetermined size or smaller.

10. The recording medium according to claim 9, characterized in that the unused area existing in the predetermined section including the recorded area is the area including the defective sector possibly incapable of recording the data.

11. The recording medium according to claim 9, characterized in that the predetermined size is determined so that the size of the unused area allowed to exist in the predetermined section including the recorded area is a small ratio to the size of the predetermined section in the case where the data rate of the recorded real-time data is high and is a large ratio in the case where the data rate is low.

12. The recording medium according to claim 11, characterized in that the predetermined size is determined so that the size of the unused area allowed to exist in the predetermined section including the recorded area is the predetermined size to the size of the predetermined section regardless of the data rate.

13. A reproducing apparatus of reproducing data from a recording medium having real-time data including at least one of audio data and video data in a minimum unit of a sector recorded thereon, characterized in that the apparatus reproducing the data from the recording medium in which a size of an unused area existing in a predetermined section including an area where the data is recorded is a predetermined size or smaller.

14. The reproducing apparatus of reproducing the data from the recording medium according to claim 13, characterized in that the unused area existing in the predetermined section including the recorded area is the area including the defective sector possibly incapable of recording the data.

15. The reproducing apparatus of reproducing the data from the recording medium according to claim 13, characterized in that the predetermined size is determined so that the size of the unused area allowed to exist in the predetermined section including the recorded area is a small ratio to the size of the predetermined section in the case where the data rate of the recorded real-time data is high and is a large ratio in the case where the data rate is low.

16. The reproducing apparatus of reproducing the data from the recording medium according to claim 15, characterized in that the predetermined size is determined so that the size of the unused area allowed to exist in the predetermined section including the recorded area is the predetermined size to the size of the predetermined section regardless of the data rate.

17. A reproducing method of reproducing data from a recording medium having real-time data including at least one of audio data and video data in a minimum unit of a sector recorded thereon, characterized in that the data is reproduced from the recording medium in which a size of an unused area existing in a predetermined section including an area where the data is recorded is a predetermined size or smaller.

18. The reproducing method of reproducing the data from the recording medium according to claim 17, characterized in that the unused area existing in the predetermined section including the recorded area is the area including the defective sector possibly incapable of recording the data.

19. The reproducing method of reproducing the data from the recording medium according to claim 17, characterized in that the predetermined size is determined so that the size of the unused area allowed to exist in the predetermined section including the recorded area is a small ratio to the size of the predetermined section in the case where the data rate of the recorded real-time data is high and is a large ratio in the case where the data rate is low.

20. The reproducing method of reproducing the data from the recording medium according to claim 19, characterized in that the predetermined size is determined so that the size of the unused area allowed to exist in the predetermined section including the recorded area is the predetermined size to the size of the predetermined section regardless of the data rate.
